(19) United States
(12) Patent Application Publication
(10) Pub. No.: US 2021/0089874 A1
(43) Pub. Date: Mar. 25, 2021

(54) ULTRA-LOW POWER KEYWORD SPOTTING NEURAL NETWORK CIRCUIT

(71) Applicant: SOUTHEAST UNIVERSITY, Nanjing (CN)

(72) Inventors: Weiwei SHAN, Nanjing (CN); Boyang CHENG, Nanjing (CN); Jun YANG, Nanjing (CN); Longxing SHI, Nanjing (CN)

(21) Appl. No.: 17/112,329

(22) Filed: Dec. 4, 2020

(30) Foreign Application Priority Data
Apr. 20, 2020 (CN) 202010309487.7

(51) Int. Cl. G06N 3/063; G06N 3/04; G06F 1/3203

(52) U.S. Cl. CPC G06N 3/063; G06F 1/3203; G06N 3/04

(57) ABSTRACT

It discloses an ultra-low power keyword spotting neural network circuit and a method for mapping data. A neural network model used is a depthwise separable convolutional neural network, of which a weight value and an intermediate activation value are both binarized during training, to obtain a lightweight neural network model with a small memory size and a small computation quantity. The circuit is designed on the basis of a data processing unit array, utilizes a memory module to memorize a weight parameter and intermediate data of a keyword spotting neural network, data control and accuracy configuration of the data processing unit array are completed by means of a control module and a data mapping module, and the data processing unit array performs a neural network computation with hybrid accuracy; and the method for mapping the data configures.

This application claims priority to Chinese Patent Application Ser. No. CN202010309487.7 filed on 20 Apr. 2020.

### FIELD OF TECHNOLOGY

The present invention belongs to the field of low-power circuit design, particularly to the aspect of low-power keyword spotting circuits, is used for reducing a power of the circuit of a neural network computation during keyword spotting, so as to keep the circuit operating at an ultra-low power in a normally-on state and complete a function of keyword spotting.

### BACKGROUND

With a computer technology rapidly developed, research on man-machine interaction has become increasingly popular, speech is important means for information communication, and thus speech recognition has gained increasing concern from people. For man-machine interaction, speech recognition is the most natural and convenient interaction means compared with interaction modes such as gesture recognition, touch type interaction and visual tracking. A keyword spotting technology is an important branch of a speech recognition technology and presents as an entrance of speech recognition in general. A large-scale speech recognition technology is to make a machine understand what people say and recognize a human language while the keyword spotting technology is to spot the machine. The difference between the keyword spotting technology and a universal large-scale semantic recognition technology lies in that for keyword spotting, it is only needed to recognize whether one or some specific words are included in a speech signal without completely recognizing the meaning of the entire section of the speech signal.

A keyword spotting circuit plays a role as a switch of a device, and the presence of keyword spotting may make the electronic device in a standby or off state most of the time without being in a work state to receive a command for a long time, thereby assisting the device in saving on a power. That is, in terms of function, a keyword spotting system may be deemed as a “speech switch.” A task of spotting by a specific keyword is easy without precisely recognizing the concrete meaning of every speech word, it is only needed to distinguish the specific word from any other speech signals including other words and an environmental noise, and therefore, keyword spotting can be deemed as a small-resource keyword search task, wherein a small resource means that a computation resource and a memory resource are small. Although the task is easy, and the occupied computation resource and memory resource are small, the attribute, serving as the “speech switch”, of the keyword spotting circuit is meant for being in the work state for a long time, the electronic device may be dormant for a long time but the keyword spotting system, as the switch for spotting the device, has to be in the work state all the time and receive the speech signal from the outside world all the time, so as to spot the entire electronic device after recognizing the word for spotting. With an Internet of Things technology developed, lots of electronic devices are powered by batteries or chargeable devices, and thus the power of the keyword spotting system, an electronic system in the work state for a long time, is extremely important. How to design a keyword spotting circuit with small resource occupancy and low power will directly influence standby and work times of the whole set of the electronic device.

An end-to-end keyword spotting system is a novel keyword spotting system, which integrates all traditional models of an acoustic model of a hidden Markov model, a pronouncing dictionary, etc. into one neural network, a training process of the acoustic model is converted to a training process of the neural network, a parameter after training of the acoustic model is also converted to a weight parameter of a depthwise neural network (the weight parameter is referred to as the parameter for short below). A recognition process from the speech signal to an output result is a forward reasoning process of one neural network, and since training of different layers of the neural network is completed through joint coordination, the parameter is more convenient to globally optimize by means of the end-to-end system based on the neural network. Hence, a neural network computation also becomes a main part in the end-to-end keyword spotting system, and the requirement on the low power of the neural network circuit also becomes more and more urgent.

A depthwise separable convolutional neural network has fewer parameters and a fewer computation quantity than a conventional convolutional neural network, and therefore is expected to be used to ultra-low power keyword spotting. A computation process of a depthwise separable convolution is similar to a computation of a traditional convolution, but divides a three-dimensional accumulation process of the traditional convolution into two times with one time in space and the other time in depth. For input data of M channels, regarding the convolution in the first step, the channels are separated, and therefore, the convolution is a convolution in two-dimensional space instead of three-dimensional space, a total scale of a depthwise separable kernel (DS kernel) is equivalent to a scale of a convolution kernel of a common convolution. A channel-separated convolution is the convolution in the first step, but a result obtained is still for the M channels. A computation of the convolution in the second step is to perform a computation of a fusion convolution on data among the channels, however, during the convolution in the first step, data of the other two dimensions have already been subjected to a fusion convolution, the convolution in the second step is just to fuse data of M different channels, and thus a scale of a pointwise kernel (PW kernel) is 1×1×M, that is, N in total (N denotes the number of output channels). The sum of the computation quantity and the parameter quantity is approximately equal to 1/N of that of a convolutional neural network of the same size.

The present invention provides an ultra-low power keyword spotting neural network circuit and a method for mapping data. A neural network model used is the depthwise separable convolutional neural network, of which a weight value and an intermediate activation value are both binarized during training, so as to obtain a lightweight neural network model with a small memory size and a small computation quantity. The neural network circuit of the present invention can complete a neural network computation with hybrid data accuracy, and performs, according to different accuracy features, gating on the data, so as to effectively reduce a data flip rate, and accordingly, the binarized depthwise separable convolutional neural network circuit is designed, so as to greatly reduce the power of the neural network circuit.

### SUMMARY

An objective of the invention: the present invention provides an ultra-low power keyword spotting neural network circuit, through which a power of the circuit is effectively reduced on the premise of completing a computation function of a neural network.

The technical solution: the technical solution provided by the present invention is as follows:

the present invention optimizes, on the basis of a binarized depthwise separable convolutional neural network model and according to memory of a hardware circuit and characteristics of computational data, an architecture of the neural network, reduces, on the basis of ensuring the accuracy of network recognition, the memory size and the computation quantity required, so as to meet the requirement of low storage and the low computation quantity of the hardware circuit, and hereby designs a low-power keyword recognition circuit.

A dataset used during training of the neural network in the present invention is a Google speech commands Dataset (GSCD for short) and LibriSpeech, and a task is to recognize two keywords. The neural network model used is a depthwise separable convolutional neural network (DSCNN), including a convolutional layer, a depthwise separable convolutional layer, a pooling layer and a full connection layer, and data of all the other layers are all binarized except that the first convolutional layer uses an input bit width of 8 bits. Binarization means that the data are denoted by 0 and 1, that is, the 1 bit data are used. The binarized neural network can greatly reduce the bit width, thereby reducing the power. The binarized neural network is divided into two types, for the first type, a weight is binarized, for the second type, the weight and an activation value are both binarized, and the second type fully-binarized network is used herein. The weight and a bias obtained with this neural network model and on the basis of training a large number of samples are used for providing a corresponding weight value and bias value for the neural network circuit.

An input of the ultra-low power keyword spotting neural network circuit is a frequency spectrum feature value of a speech signal, an output signal is a spotting indication sign, and if a correct keyword is recognized, the data are set to 1, and otherwise maintained at 0. The computation circuit of the neural network is designed on the basis of the above-mentioned structure of the neural network. A memory module memorizes weight and bias parameters of the neural network and input, output and intermediate computation data. A data mapping module maps and distributes the data of the memory module to a data processing unit array. The data processing unit array is configured to complete a multiply-accumulate computation of the neural network, and meanwhile, completes a computation function of an activation function, of which the data accuracy may be configured with two modes of 1 bit and 8 bits. A control module controls an operation state of the entire circuit and cooperates with all the modules to complete the neural network computation.

The data mapping module selects, according to the requirement of the data accuracy of a control state, whether to perform gating processing on the input data, so as to satisfy the two data accuracy modes of 8 bits and 1 bit, thereby completing the neural network computation with hybrid accuracy, in the mode of 1 bit, seven upper bits of the input data are all 0, a digital high level denotes actual data+1, a low level denotes data−1, and therefore, a data flip rate can be effectively reduced, so as to reduce the power of the circuit.

The specific technical solution is as follows:

the neural network model used by the ultra-low power keyword spotting neural network circuit is the depthwise separable convolutional neural network, differing from a traditional convolutional network structure, a depthwise separable convolution uses a two-dimensional convolutional mode, thereby greatly reducing memory of the weight and the data computation quantity, and reducing the static power of a memory array in the hardware circuit and the dynamic power of data flip without losing the recognition accuracy. In the present invention, the task of the keyword spotting neural network is to recognize two keywords, that is, a three-class task, and a classification result is a keyword 1, a keyword 2 and a filler. A training sample is the GSCD of single audio and a LibriSpeech dataset of long audio. In order to meet the requirement of low storage and the low computation quantity of computation of hardware, in a network training process, the number of layers of the network and the data quantization accuracy are continuously adjusted, a scale of the network is narrowed on the premise of ensuring the recognition accuracy, the final neural network uses the binarized weight and the binarized activation value, and all the other intermediate computation results are quantized to 1 bit except that input data of the first layer are in 8 bits.

The architecture of the neural network circuit is designed by using software and hardware in a coordinated mode, and the number of array type processing units is adapted to a size of a memory unit, to make the number of rows of each memory sub-unit and the number of the array type processing units equal to the number of channels of a convolution kernel, that is M, wherein M is an integer greater than 1. The neural network circuit is mainly composed of the memory module, the data mapping module, the data processing unit array and the control module. The memory module is responsible for memorizing the weight and bias parameters required during the neural network computation and the input, output and intermediate computation data, wherein the input data are derived from an input of the frequency spectrum feature value of the spotting speech signal. The data mapping module maps and distributes, according to a computation rule of the neural network, the data in the memory module to the data processing unit array. The data processing unit array is configured to complete a large number of multiply-accumulate computations in a computation process of the neural network, of which the data accuracy may be configured, according to different control and mapping modes of the data mapping module, with the two modes of 1 bit and 8 bits, and meanwhile, the data processing unit array can complete the computation function of the activation function in the neural network. A control signal of the control module controls the memory module, the data mapping module and the data processing unit array, controls the operation state of the entire circuit and cooperates with all the modules to complete the neural network computation.

The memory module may be subdivided into five modules, that is, a weight memory array memorizing the weight parameter of the neural network, a bias memory array memorizing the bias parameter of the neural network, a feature memory array memorizing input feature data and two intermediate data memory arrays memorizing computation results of an intermediate layer, wherein input and output data of a current network layer are memorized in the two intermediate data memory arrays respectively. The memory module with a large memory scale uses block design, and the number of the rows of each memory sub-unit and the number of the data processing units are equal to the number of the channels of the convolution kernel, that is M.

The data mapping module is mainly composed of gating logic and maps, according to network characteristics, such as a structure, a connection mode and a scale of each layer of the neural network and the computation rule of the structure of the neural network, the data in the memory module to the data processing unit array for the computation, of which a specific state is controlled by the control module.

The data processing unit array is composed of M data processing units, wherein M is an integer greater than 1, for example, 32 herein. The data of the data processing unit array are derived from the data mapping module, each of the data processing units completes a multiply-accumulate computation of data of one input channel of the neural network, each of the data processing units is internally provided with a multiply-accumulate unit and an activation circuit, and the data processing unit array is responsible for completing all multiply-accumulate computations in the neural network. The computation result of the data processing unit array is memorized into the intermediate data memory array of the memory module. Since the number of the array type processing units is adapted to the size of the memory unit, the M data processing units can complete the multiply-accumulate computations of M channels at one time, thereby greatly saving on a reading and writing time and the reading and writing power of the memory unit while improving the operation efficiency.

The control module is mainly composed of two nesting state machines, wherein an upper-layer state machine controls interlayer skip, of which a state indicates at which layer a computation of the neural network is performed by the neural network circuit at present, and a lower-layer state machine controls specific behavior, including data loading, accumulation, bias addition, activation, output, etc., of the memory module, the data mapping module and the data processing unit array.

A method for mapping data of a neural network circuit includes: selecting, by a data mapping module according to the requirement of the data accuracy of a control state (the control state includes a convolutional operation, a separable convolutional operation, a pooling operation and a full connection operation), whether to perform gating processing on input data, so as to satisfy two data accuracy modes of 8 bits and 1 bit, thereby completing a neural network computation with hybrid accuracy.

The beneficial effects of the present invention are as follows:

1. the neural network model used by the present invention is the depthwise separable convolutional neural network which greatly reduces the data computation quantity and the parameter memory quantity compared with a convolutional network, and of which the weight value and the intermediate activation value are both binarized during training, so as to obtain a lightweight neural network model with a small memory size and a small computation quantity;

2. the architecture of the neural network circuit is designed by using software and hardware in the coordinated mode, the number of the array type processing units is adapted to the size of the memory unit, to make the number of the rows of each memory sub-unit and the number of the array type processing units equal to the number of the channels of the convolution kernel, that is M, and therefore, during the computation, convolutional operations of the M channels can be completed at one time, the operation efficiency is high and the reading and writing power of the memory unit is reduced;

3. the method for mapping the data used by the present invention can flexibly configure the data accuracy of the data processing unit, to make the data accuracy of the neural network circuit flexibly configured; and the present invention uses the M data processing units to construct both convolutional layers and the full connection layer and complete the operations of max-pooling, solving the activation value, etc.

### BRIEF DESCRIPTION OF THE DRAWINGS

FIG. 1 is a schematic structural diagram of a depthwise separable convolutional layer;

FIG. 2 is an overall structural diagram of a depthwise separable neural network of the present invention;

FIG. 3 is a structural diagram of a circuit of a neural network circuit of the present invention;

FIG. 4 is a structural diagram of a circuit of a multiply-accumulate unit of the present invention;

FIG. 5 is a sequence diagram of the circuit of the multiply-accumulate unit of the present invention; and

FIG. 6 is a structural diagram of an activation circuit of the present invention.

### DESCRIPTION OF THE EMBODIMENTS

The present invention is further described below in conjunction with the accompanying drawings.

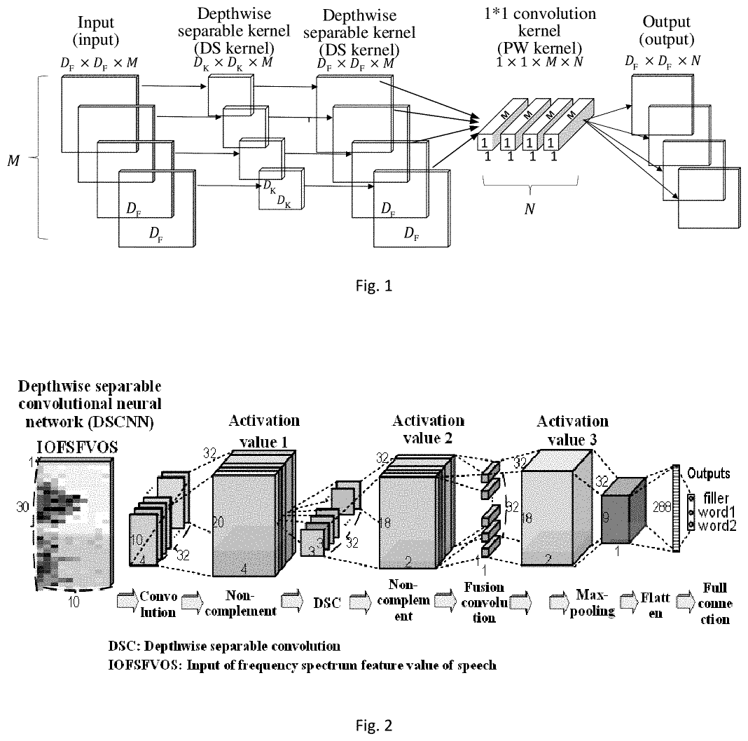

FIG. 1 is a schematic structural diagram of a depthwise separable convolutional layer. A computation process of a depthwise separable convolution is similar to a computation of a traditional convolution but divides a three-dimensional accumulation process of the traditional convolution into two times with one time in space and the other time in depth. For input data of M channels, regarding the convolution in the first step, the channels are separated, and therefore, the convolution is a convolution in two-dimensional space instead of three-dimensional space, and a total scale of a depthwise separable kernel (DS kernel) is equivalent to a scale of a convolution kernel of a common convolution. A channel-separated convolution is the convolution in the first step, but a result obtained is still for the M channels. A computation of the convolution in the second step is to perform a computation of a fusion convolution on data among the channels, however, during the convolution in the first step, data of the other two dimensions have already been subjected to a fusion convolution, the convolution in the second step is just to fuse data of M different channels, and thus a scale of a pointwise kernel (PW kernel) is 1×1×M, that is, N in total.

In order to facilitate the comparison of a parameter of a depthwise separable network and the computation reduction quantity, scales of the first two dimensions of an input image are set to the same DF and a size of the input image is D_{F}×D_{F}×M. A size of the depthwise separable kernel is D_{K}×D_{K}×M; and a size of the pointwise kernel is 1×1×M×N, wherein M is the number of input channels, and N is the number of output channels.

A method for the traditional convolution uses a 3-D convolution which directly uses a convolution kernel of D_{K}×D_{K}×M×N, and of which the weight parameter quantity S_{w} and the computation quantity Sₒₚ respectively are:

S_{w}=D_{K}·D_{K}·M·N (1)

Sₒₚ=D_{F}·D_{F}·M·N·D_{K}·D_{K} (2)

however when the depthwise separable convolution is used, the total parameter quantity S′_{W} and the total computation quantity S′ₒₚ of the depthwise separable kernel and the pointwise kernel respectively are:

S′_{w}=D_{K}·D_{K}·M+M·N (3)

S′ₒₚ=D_{F}·D_{F}·M·D_{K}·D_{K}+M·N·D_{F}·D_{F} (4)

and therefore, compared with the traditional convolution, for the same input and output parameters, a parameter reduction ratio R_{w} and a computation quantity reduction ratio Rₒₚ that may be brought by the depthwise separable convolution are respectively:

$$\begin{matrix} {R}_{w} = \frac{{S}_{w}^{′}}{{S}_{w}} = \frac{{D}_{K} * {D}_{K} * M + M * N}{{D}_{K} * {D}_{K} * M * N} = \frac{1}{N} + \frac{1}{{D}_{K}^{2}} & ( 5 ) \\ {R}_{op} = \frac{{S}_{op}^{′}}{{S}_{op}} = \frac{{D}_{F} * {D}_{F} * M * {D}_{K} * {D}_{K} + M * N * {D}_{F} * {D}_{F}}{{D}_{F} * {D}_{F} * M * N * {D}_{K} * {D}_{K}} = \frac{1}{N} + \frac{1}{{D}_{K}^{2}} & ( 6 )\end{matrix}$$

and it can be seen that the larger an area of the convolution kernel is, the larger the number of the output channels is, and the larger the reduction quantities of the parameter and the computation quantity to be memorized by the neural network is. In practical use, at least 3×3 is taken as D_{K}×D_{K}, and the number N of channels is usually large, which is 32 or higher in general. Hence, no matter the parameter quantity or the computation quantity, when the convolution kernel is 3×3, the depthwise separable network will make nine times or so larger reduction quantity than the traditional convolution.

FIG. 2 is an overall structural diagram of the depthwise separable neural network of the present invention, and the depthwise separable neural network includes a convolutional layer, a depthwise separable convolutional layer, a pooling layer and a full connection layer, wherein data of all the other layers are all binarized 1 bit data except that the first convolutional layer uses an input bit width of 8 bits. A weight and a bias obtained with this neural network model and on the basis of training a large number of samples are used for providing a corresponding weight value and bias value for a neural network circuit.

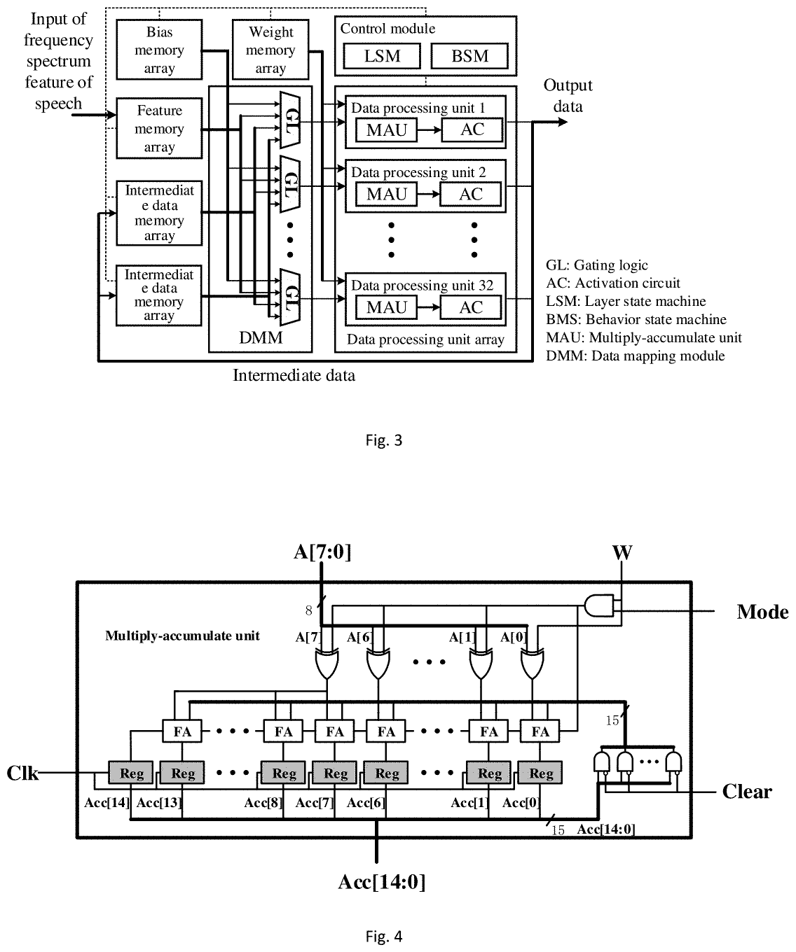

FIG. 3 is an overall structural diagram of an ultra-low power keyword spotting neural network circuit, wherein the circuit is mainly composed of a data processing unit array, a memory module, a data mapping module, a control module, etc. The data processing unit array is composed of 32 data processing units, one data processing unit is responsible for multiplying-accumulating data of one channel, each of the data processing units is internally provided with a multiply-accumulate unit and an activation circuit, and the data processing units are responsible for completing all multiply-accumulate computations in the neural network; the memory module may be subdivided into five modules, that is, a weight memory array memorizing a weight parameter of the network, a bias memory array memorizing the bias, a feature memory array memorizing input feature data and two intermediate data memory arrays memorizing computation results of an intermediate layer; the data mapping module is mainly composed of some gating logic and is responsible for selecting, under different state control, different data sources to enter the data processing unit array for a computation; and the control module is mainly composed of two nesting state machines, wherein an upper-layer state machine controls interlayer skip, of which a state indicates at which layer a computation of the network is performed by the neural network circuit at present, and a lower-layer behavior state machine controls specific behavior, including data loading, accumulation, bias addition, output, etc., of the data processing unit array, the data mapping module and all the memory arrays, wherein dotted lines in the figure denote control, by the control module, over other modules.

FIG. 4 is a structural diagram of a circuit of the multiply-accumulate unit, wherein A is 8 bit input data, W is 1 bit weight data, Mode is a mode control signal, Clear is a clear signal, Clk is a clock signal, Acc is a 15 bit accumulation result, FA is a 1 bit full adder and Reg is a register. In the circuit, logic 0 denotes weight+1, logic 1 denotes weight−1, a multiply operation may be actually converted into xor logic in the circuit, the 8 bit input data A[7:0] are separately subjected to xor with the weight data W to complete a multiplication function, a multiplication result is sent to the full adder for an accumulation, then the accumulation result Acc is temporarily memorized in the register for a next accumulation, and thus the full adder and the register complete a function of the accumulation and result storage; and Clear is the clear signal, is valid when being high to clear an original accumulation result, and only memorizes a product of a current input and the weight into the register. The Mode signal is used for distinguishing an 8 bit data accumulation from a 1 bit data accumulation, when the Mode is configured with a high level, the input data are in 8 bits, and when the Mode is configured with a low level, the input data are in 1 bit.

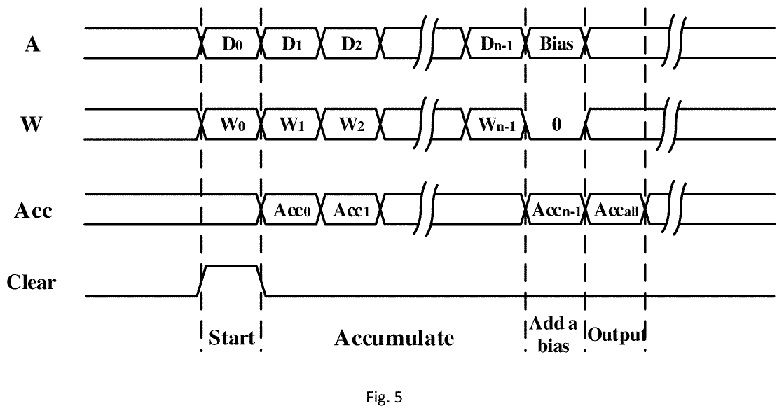

FIG. 5 is a sequence diagram of the circuit of the multiply-accumulate unit, wherein the multiply-accumulate unit is switched among four states. When the multiply-accumulate computation is started, firstly the Clear signal is pulled up, the multiply-accumulate unit enters a start state, meanwhile, the first group of input and weight data are sent therein, and when the Clear signal is high, the multiply-accumulate unit directly memorizes a product value Acc0 of an input and a weight into the register; then the multiply-accumulate unit enters an accumulation state, one group of corresponding input and weight data are sent therein in each cycle; after an accumulation of n multiplication results is completed, the bias is still added to a final result, the multiply-accumulate unit enters a bias addition state, and at the moment, the weight W is set to 0, which is equivalent to an accumulation of a product of +1 and the bias and a last result; and after an accumulation operation is completed, the multiply-accumulate unit enters an output state, a final accumulation result is transmitted, through an Acc signal, to the activation circuit for a computation of an activation value.

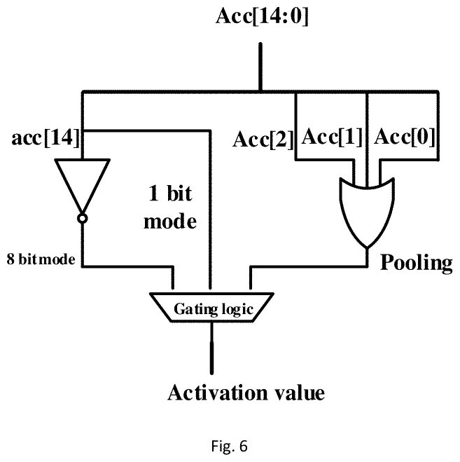

FIG. 6 is a structural diagram of the activation circuit, the Acc is derived from the accumulation result of the multiply-accumulate unit and has three modes, including a mode when the input data are in 8 bits, a mode when the input data are in 1 bit and a mode when max-pooling of 2×2 is computed, and results of the three modes are output by gating, so as to obtain a result of the activation value in a certain specific mode. An operation of solving max-pooling and then solving the activation value in a reasoning operation of the binarized neural network is converted into the multiply-accumulate computation, an operation of max-pooling of K×K (K is an integer greater than 1) is equivalent to an accumulation of K×K input data, if an accumulation result is 0, the activation value is output as 0, and if the accumulation result is not 0, the activation value is output as 1.

What is claimed is:

1. An ultra-low power keyword spotting neural network circuit, wherein a depthwise separable convolutional neural network is used as a neural network model, comprising a memory module (1), a data processing unit array (2), a data mapping module (3) and a control module (4), the memory module (1) being responsible for memorizing data required by a neural network computation, the data mapping module (3) mapping and distributing, according to a computation rule of the depthwise separable convolutional neural network, the data in the memory module (1) to the data processing unit array (2), the data processing unit array (2) being configured to complete all multiply-accumulate computations in the neural network, of which the data accuracy may be configured, according to different control and mapping modes of the data mapping module (3), with two data accuracy modes of 1 bit and 8 bits, and the control module (4) controlling an operation state of the neural network circuit and cooperating with all the modules to complete the neural network computation.

2. The ultra-low power keyword spotting neural network circuit of claim 1, wherein the memory module is composed of a plurality of memory sub-modules, and the number of rows of each of the memory sub-modules is equal to the number of channels of a neural network convolution kernel.

3. The ultra-low power keyword spotting neural network circuit of claim 1, wherein the memory module (1) comprises a weight memory array memorizing a weight parameter of the neural network, a bias memory array memorizing a bias parameter of the neural network, a feature memory array memorizing input feature data and an intermediate data memory array memorizing a computation result of an intermediate layer, an output of the weight memory array is connected with the data processing unit array (2), and outputs of the bias memory array, the feature memory array and the intermediate data memory array are connected with the data mapping module (3).

4. The ultra-low power keyword spotting neural network circuit of claim 1, wherein the data processing unit array (2) is composed of a plurality of data processing units, the number of the data processing units is equal to the number of channels of a neural network convolution kernel, and each of the data processing units completes a multiply-accumulate computation of data of one input channel of the neural network.

5. The ultra-low power keyword spotting neural network circuit of claim 4, wherein the data processing unit comprises a multiply-accumulate unit and an activation circuit, an input of the multiply-accumulate unit is connected with outputs of the data mapping module (3) and the data processing unit array (2), an output of the multiply-accumulate unit is connected with an input of an activation circuit, and an output of the activation circuit serves as an output of the neural network circuit and is memorized in the memory module (1).

6. The ultra-low power keyword spotting neural network circuit of claim 1, wherein the data memorized by the memory module comprise a weight parameter and a bias parameter required by the neural network computation and input, output and intermediate computation data, and the input data are derived from an input of a frequency spectrum feature value of a speech signal for spotting.

7. The ultra-low power keyword spotting neural network circuit of claim 1, wherein the depthwise separable convolutional neural network provides a weight value and a bias value for the neural network circuit, and comprises a convolutional layer, a depthwise separable convolutional layer, a pooling layer and a full connection layer, a binarized weight and a binarized activation value are used, and data of all the other layers are all binarized 1 bit data except that the first convolutional layer uses an input bit width of 8 bits.

8. The ultra-low power keyword spotting neural network circuit of claim 1, wherein the data mapping module (3) is mainly composed of a gating logic circuit, and maps, under the control of the control module (4) and according to network characteristics of the neural network and the computation rule of the neural network, the data in the memory module (1) to the data processing unit array (2) for the computation.

9. The ultra-low power keyword spotting neural network circuit of claim 1, wherein the control module (4) is mainly composed of two nesting state machines, an upper-layer state machine controlling interlayer skip, of which a state indicates at which layer a computation of the network is performed by the neural network circuit at present, and a lower-layer state machine controlling specific behavior, including data loading, accumulation, bias addition, activation and output, of the memory module (1), the data mapping module (3) and the data processing unit array (2).

10. The ultra-low power keyword spotting neural network circuit of claim 1, wherein the data mapping module (3) selects, according to the requirement of the data accuracy, whether to perform gating processing on input data, so as to satisfy the two data accuracy modes of 1 bit and 8 bits, and in the data accuracy mode of 1 bit, seven upper bits of the input data are all 0, a digital high level denotes actual data+1, and a low level denotes data−1.

11. The ultra-low power keyword spotting neural network circuit of claim 1, wherein the data processing unit array (2) uses the multiply-accumulate computation to realize an operation of solving max-pooling and an activation value in a reasoning operation of the neural network, an operation of max-pooling of K×K is equivalent to an accumulation of K×K input data, K is an integer greater than 1, when an accumulation result is 0, the activation value is output as 0, and when an accumulation result is not 0, the activation value is output as 1.

12. The ultra-low power keyword spotting neural network circuit of claim 2, wherein the memory module (1) comprises a weight memory array memorizing a weight parameter of the neural network, a bias memory array memorizing a bias parameter of the neural network, a feature memory array memorizing input feature data and an intermediate data memory array memorizing a computation result of an intermediate layer, an output of the weight memory array is connected with the data processing unit array (2), and outputs of the bias memory array, the feature memory array and the intermediate data memory array are connected with the data mapping module (3).
